(19) United States
(12) Patent Application Publication
(10) Pub. No.: US 2023/0312905 A1
(43) Pub. Date: Oct. 5, 2023

(54) ACRYLIC RESIN COMPOSITION AND RESIN FILM

(71) Applicant: KANEKA CORPORATION, Osaka (JP)

(72) Inventors: Fuminobu Kitayama, Osaka (JP); Takuya Kamimura, Osaka (JP); Hirotsugu Yamada, Hyogo (JP)

(73) Assignee: KANEKA CORPORATION, Osaka (JP)

(21) Appl. No.: 18/332,448

(22) Filed: Jun. 9, 2023

Related U.S. Application Data
(63) Continuation of application No. PCT/JP2021/045605, filed on Dec. 10, 2021.

(30) Foreign Application Priority Data
Dec. 11, 2020 (JP) 2020-206288

(51) Int. Cl. C08L 33/12; C08K 5/42; B29C 41/24; G02B 5/30; C08F 2/26; C08F 220/14; B29C 41/00

(52) U.S. Cl. CPC C08L 33/12; C08K 5/42; B29C 41/24; G02B 5/30; C08F 2/26; C08F 220/14; B29C 41/003; C08L 2207/53; C08L 2203/16; B29K 2033/12

(57) ABSTRACT

An acrylic resin composition for use in film production by solution casting contains an acrylic polymer containing, as structural units, 30 to 100 wt % of methyl methacrylate units and 0 to 70 wt % of other monomer units copolymerizable with the methyl methacrylate units; and an ionic emulsifier. The content of the ionic emulsifier is from 0.1 to 10 parts by weight per 100 parts by weight of the acrylic polymer.

### TECHNICAL FIELD

One or more embodiments of the present invention relate to an acrylic resin composition used to produce a film by solution casting and to a resin film produced by solution casting using the composition.

### BACKGROUND

TAC (triacetyl cellulose) has been used in polarizer protective films of liquid crystal displays. Recent years have seen increases in screen size and definition of liquid crystal displays and the corresponding emergence of a problem due to the use of TAC. The high moisture permeability and water absorbency of TAC cause warping of panels during transportation, resulting in degraded image quality.

Acrylic resin films have excellent optical properties, low moisture permeability, and low water absorbency, because of which they are attracting attention as an alternative to TAC films.

Patent Literature 1 discloses a technique for film production in which an acrylic resin is formed into a film by solution casting. In this technique, the conditions in a drying step, such as the residual solvent amount and the temperature, are optimized to prevent blushing of the resulting film or bubble formation in the film.

Patent Literature 2 discloses that a film excellent in optical properties, dimensional stability, and bond performance can be obtained by solution casting using an acrylic polymer obtained by suspension polymerization in the presence of a suspension polymerization dispersant having a particular structure.

### PATENT LITERATURE

PTL 1: Japanese Laid-Open Patent Application Publication No. 2014-177089
PTL 2: Japanese Laid-Open Patent Application Publication (Translation of PCT Application) No. 2019-533203

The technique of Patent Literature 1 requires control of complicated production conditions such as the residual solvent amount and the temperature conditions. The technique of Patent Literature 2 needs the use of a suspension polymerization dispersant having a unique structure and leaves room for improvement. It has also been found that solution casting using an acrylic resin composition could, depending on the makeup of the composition, suffer from not only the above-mentioned bubble formation in the resulting film but also reduced transparency of a dope containing the composition.

In view of the above circumstances, one or more embodiments of the present invention aims to provide an acrylic resin composition used to produce a film by solution casting, the acrylic resin composition being adapted to improve the transparency of a dope containing the composition and reduce the formation of bubble marks on the surface of an acrylic resin film produced by solution casting.

### SUMMARY

As a result of intensive studies, the present inventors have come to focus on components of an acrylic resin composition that are other than a main polymer (the other components include auxiliary materials for the main polymer production and components called foreign substances) and have found that controlling the types and contents of the other components can improve the transparency of a dope containing the acrylic resin composition and reduce the likelihood that the surface of an acrylic resin film produced by solution casting has bubble marks formed during drying in the film production. Based on this finding, the inventors have completed one or more embodiments of the present invention.

Specifically, one or more embodiments of the present invention relate to an acrylic resin composition for use in film production by solution casting, the acrylic resin composition containing: an acrylic polymer containing, as structural units, 30 to 100 wt % of methyl methacrylate units and 0 to 70 wt % of other monomer units copolymerizable with the methyl methacrylate units; and an ionic emulsifier, wherein a content of the ionic emulsifier is from 0.1 to 10 parts by weight per 100 parts by weight of the acrylic polymer.

The ionic emulsifier may be a sulfonate salt.

The sulfonate salt may include at least one selected from the group consisting of a lithium salt, a sodium salt, and a potassium salt.

The sulfonate salt may include at least one selected from the group consisting of a dialkyl sulfosuccinate salt, an alkane sulfonate salt, an α-olefin sulfonate salt, an alkylbenzene sulfonate salt, a naphthalene sulfonate salt-formaldehyde condensate, an alkylnaphthalene sulfonate salt, and a N-methyl-N-acyl taurine salt.

Preferably, the other copolymerizable monomer units include (meth)acrylic ester units that are other than methyl methacrylate units and that have an ester moiety having 1 to 20 carbon atoms and/or maleimide units.

A content of the other copolymerizable monomer units may be from 0.1 to 50 wt % based on total structural units of the acrylic polymer.

The acrylic resin composition may further contain 1 to 50 parts by weight of a graft copolymer having a core-shell structure per 100 parts by weight of the acrylic polymer.

A weight-average molecular weight of the acrylic polymer may be 50×10⁴ or more.

A haze of a solution dope containing the acrylic resin composition at a concentration of 5 wt % in a solvent mixture of 95 wt % methylene chloride and 5 wt % methanol may be 5% or less.

One or more embodiments of the present invention also relate to a resin film produced by molding the acrylic resin composition by solution casting.

A haze of the resin film may be 2% or less.

The resin film may be a protective film to be disposed on a surface of a base material.

The resin film may be a polarizer protective film.

One or more embodiments of the present invention further relate to a polarizing plate including a polarizer and the resin film disposed on the polarizer and to a display device including the polarizing plate.

One or more embodiments of the present invention further relate to a method for producing the acrylic resin composition, the method including: performing emulsion polymerization or suspension polymerization in the presence of an ionic emulsifier to obtain a liquid mixture containing the acrylic polymer and water; and performing a drying process on the liquid mixture without performing any washing process.

One or more embodiments of the present invention further relate to a resin film production method including forming a dope into a film by solution casting, wherein the dope contains the acrylic resin composition and a solvent.

The solvent may contain 1 to 25 wt % of an alcohol.

The alcohol may include ethanol and/or methanol.

One or more embodiments of the present invention can provide an acrylic resin composition used to produce a film by solution casting, the acrylic resin composition being adapted to improve the transparency of a dope containing the composition and reduce the formation of bubble marks on the surface of an acrylic resin film produced by solution casting.

An acrylic resin film produced by solution casting using the acrylic resin composition according to one or more embodiments of the present invention can be a film that is not likely to have on its surface bubble marks formed during drying in the film production, that has a good appearance, and that has high transparency. Such an acrylic resin film has few optical defects and exhibits high light extraction efficiency. Thus, this film is suitable for use as an optical film for a liquid crystal display member, in particular as a polarizer protective film.

### BRIEF DESCRIPTION OF THE DRAWINGS

FIG. 1 is a microscope image of the surface of a film made for evaluation of the bubble formation level by using a resin composition obtained in Example 1.

FIG. 2 is a microscope image of the surface of a film made for evaluation of the bubble formation level by using a resin composition obtained in Comparative Example 1.

### DETAILED DESCRIPTION

Hereinafter, one or more embodiments of the present invention will be described in detail. One or more embodiments of the present invention are not limited to the described embodiments.

(Acrylic Resin Composition)

An acrylic resin composition of one or more embodiments of the present invention contains at least: an acrylic polymer containing, as structural units, 30 to 100 wt % of methyl methacrylate units and 0 to 70 wt % of other monomer units copolymerizable with the methyl methacrylate units; and an ionic emulsifier, and the content of the ionic emulsifier is from 0.1 to 10 parts by weight per 100 parts by weight of the acrylic polymer. By virtue of this makeup of the composition, resin film production by solution casting using the composition is not likely to suffer from the formation of bubble marks attributed to a drying step and can yield a film having high transparency.

(Acrylic Polymer)

The acrylic polymer contained in the acrylic resin composition according to one or more embodiments contains, as structural units, 30 to 100 wt % of methyl methacrylate units and 0 to 70 wt % of other monomer units copolymerizable with the methyl methacrylate units.

In terms of appearance and weathering resistance, the acrylic polymer contains 30 wt % or more of methyl methacrylate units in the total structural units of the polymer. The content of methyl methacrylate units may be 50 wt % or more, 60 wt % or more, 70 wt % or more, or 80 wt % or more. In terms of optical properties and heat resistance, the content of methyl methacrylate units may be at most 99.9 wt %, 99 wt % or less, 97 wt % or less, or 95 wt % or less. In terms of workability and appearance, the acrylic polymer may contain no monomer units derived from a polyfunctional monomer having two or more polymerizable functional groups in the molecule.

Examples of the other monomer units copolymerizable with methyl methacrylate units include: (meth)acrylic ester units (other than methyl methacrylate units) having an ester moiety having 1 to 20 carbon atoms, such as ethyl methacrylate, propyl methacrylate, butyl methacrylate, cyclohexyl methacrylate, 2-ethylhexyl methacrylate, benzyl methacrylate, octyl methacrylate, stearyl methacrylate, glycidyl methacrylate, epoxycyclohexylmethyl methacrylate, dimethylaminoethyl methacrylate, 2-hydroxyethyl methacrylate, 2-hydroxypropyl methacrylate, dicyclopentanyl methacrylate, 2,2,2-trifluoroethyl methacrylate, 2,2,2-trichloroethyl methacrylate, isobornyl methacrylate, methyl acrylate, ethyl acrylate, propyl acrylate, butyl acrylate, 2-ethylhexyl acrylate, octyl acrylate, glycidyl acrylate, epoxycyclohexylmethyl acrylate, 2-hydroxyethyl acrylate, and 2-hydroxypropyl acrylate units; (meth)acrylamide units such as methacrylamide, N-methylolmethacrylamide, acrylamide, and N-methylolacrylamide units; carboxylic acid units such as those derived from methacrylic acid, acrylic acid, and their salts; vinyl cyanide units such as acrylonitrile and methacrylonitrile units; vinylarene units such as styrene, α-methylstyrene, monochlorostyrene, and dichlorostyrene units; maleimide units such as N-phenylmaleimide, N-cyclohexylmaleimide, and N-methylmaleimide units; units derived from maleic acid, fumaric acid, and their esters; vinyl halide units such as vinyl chloride, vinyl bromide, and chloroprene units; vinyl ester units such as vinyl formate, vinyl acetate, and vinyl propionate units; and alkene units such as ethylene, propylene, butylene, butadiene, and isobutylene units. Among these, (meth)acrylic ester units (other than methyl methacrylate units) having an ester moiety having 1 to 20 carbon atoms, vinylarene units, and/or maleimide units are preferred, and (meth)acrylic ester units (other than methyl methacrylate units) having an ester moiety having 1 to 20 carbon atoms and/or maleimide units are particularly preferred. One of the monomers as mentioned above may be used, or two or more thereof may be used.

The acrylic resin composition according to one or more embodiments is used to produce an acrylic resin film by solution casting. Thus, the other copolymerizable monomer units may include structural units derived from a drying-accelerating comonomer that increases the rate of solvent evaporation.

For the drying-accelerating comonomer units to have high heat resistance and be able to increase the rate of solvent evaporation, the comonomer units may include at least one type of units selected from the group consisting of: maleimide units; methacrylic ester units having an ester moiety that is a primary or secondary hydrocarbon group having 2 to 8 carbon atoms or that is an aromatic hydrocarbon group; methacrylic ester units having an ester moiety that is a saturated hydrocarbon group having a fused ring structure and having 7 to 16 carbon atoms; methacrylic ester units having an ester moiety that is a linear or branched group containing an ether bond; and vinylarene units. The use of such drying-accelerating comonomer units can increase the rate of solvent evaporation from a cast film in solution casting while ensuring high heat resistance of the acrylic polymer.

Examples of the maleimide units include N-phenylmaleimide, N-benzylmaleimide, N-cyclohexylmaleimide, and N-methylmaleimide units. N-Phenylmaleimide, N-benzylmaleimide, and N-cyclohexylmaleimide units are preferred.

Examples of the methacrylic ester units having an ester moiety that is a primary or secondary hydrocarbon group having 2 to 8 carbon atoms or that is an aromatic hydrocarbon group include ethyl methacrylate, propyl methacrylate, n-butyl methacrylate, hexyl methacrylate, cyclohexyl methacrylate, 2-ethylhexyl methacrylate, octyl methacrylate, phenyl methacrylate, and benzyl methacrylate units. Among these, ethyl methacrylate, n-butyl methacrylate, cyclohexyl methacrylate, 2-ethylhexyl methacrylate, and benzyl methacrylate units are preferred.

Examples of the methacrylic ester units having an ester moiety that is a saturated hydrocarbon group having a fused ring structure and having 7 to 16 carbon atoms include dicyclopentanyl methacrylate and isobornyl methacrylate units. The number of carbon atoms in the saturated hydrocarbon group may be from 8 to 14 or from 9 to 12. The fused ring structure is not limited to a particular type, but may be a structure composed of two five-membered rings fused at three adjacent carbon atoms.

Examples of the methacrylic ester units having an ester moiety that is a linear or branched group containing an ether bond include 2-methoxyethyl methacrylate units.

Examples of the vinylarene units include styrene, α-methylstyrene, monochlorostyrene, and dichlorostyrene units. Among these, styrene units are preferred.

The acrylic polymer is not particularly limited as to the other copolymerizable monomer units, except that the acrylic polymer contains the other copolymerizable monomer units in an amount of 0 to 70 wt % in the total structural units of the polymer. However, in terms of adjusting the optical properties or heat resistance of the resulting resin composition, the acrylic polymer may contain the other copolymerizable monomer units in an amount of 0.1 wt % or more, 1 wt % or more, 3 wt % or more, or 5 wt % or more. The content of the other copolymerizable monomer units may be at most 50 wt %, 40 wt % or less, 30 wt % or less, or 20 wt % or less.

In order to achieve high heat resistance, the acrylic polymer may have a ring structure in the main chain. Examples of the ring structure include a glutarimide ring structure, a lactone ring structure, a maleic anhydride-derived structure, a maleimide ring structure (including an N-substituted maleimide-derived structure), and a glutaric anhydride ring structure. Other examples include an acrylic resin containing (meth)acrylic acid structural units in the molecule. Specific examples of such an acrylic resin include: a maleimide acrylic resin (an acrylic resin resulting from copolymerization using an unsubstituted or N-substituted maleimide compound as a copolymerization component); a glutarimide acrylic resin; a lactone ring-containing acrylic resin; an acrylic or methacrylic resin containing hydroxy and/or carboxyl groups; a partially-hydrogenated styrene unit-containing acrylic polymer obtained by partial hydrogenation of the aromatic ring of a styrene-containing acrylic polymer obtained by copolymerization of a styrene monomer and another monomer copolymerizable with the styrene monomer; and an acrylic polymer having a cyclic acid anhydride structure such as a glutaric anhydride structure or a maleic anhydride-derived structure.

Among the ring structures mentioned above, a glutarimide ring structure or a maleimide ring structure is particularly preferred in terms of effectively enhancing the heat resistance of the acrylic resin film and achieving a good balance between the heat resistance and the optical properties. These ring structures may be used in combination, and the combined use can provide good optical properties, high thermal stability, and high solvent resistance to the acrylic polymer.

The weight-average molecular weight of the acrylic polymer is not limited to a particular range. In terms of toughening the resulting acrylic resin film and achieving a good balance between high toughness and good film productivity, the weight-average molecular weight may be from 40×10⁴ to 400×10⁴, from 80×10⁴ to 350×10⁴, from 80×10⁴ to 300×10⁴, or from 100×10⁴ to 300×10⁴. The weight-average molecular weight may be from 80×10⁴ to 250×10⁴ or from 80×10⁴ to 200×10⁴.

In the case where the film production is performed by melt extrusion, the acrylic polymer melted needs to have a reduced viscosity, and this is why the molecular weight of the polymer has to be relatively low. In contrast, in one or more embodiments, where the film production is performed by solution casting, the film production can easily be accomplished even when the polymer has a high molecular weight. In this light, the weight-average molecular weight of the acrylic polymer may be 50×10⁴ or more.

The weight-average molecular weight can be calculated by a standard polystyrene-equivalent method using gel permeation chromatography (GPC).

The acrylic polymer may have high heat resistance. The glass transition temperature can be used as a measure of the heat resistance. The acrylic polymer may exhibit a glass transition temperature of 110° C. or higher, 114° C. or higher, 115° C. or higher, 119° C. or higher, 122° C. or higher, or 125° C. or higher.

(Method for Producing Acrylic Polymer)

The method for producing the acrylic polymer according to one or more embodiments is not limited to a particular technique, and may be any method by which the effect of one or more embodiments of the invention can be achieved. In terms of factors such as the design flexibility of the structure of the acrylic polymer, the ease of polymerization, and the productivity, it is preferable to produce the acrylic polymer by emulsion polymerization or suspension polymerization.

Production by emulsion polymerization in which the monomers are polymerized in the presence of an ionic emulsifier is more preferred in terms of reducing the likelihood that the acrylic resin film produced by solution casting has, on its surface or in its interior, bubble marks formed during drying in the film production and allowing the film to have a good appearance and high transparency.

In particular, in the case of an acrylic polymer containing a maleimide ring structure in the main chain, the maleimide monomer remaining unreacted in the polymerization process tends to hydrolyze and thus discolor the acrylic polymer. It is preferable to produce the acrylic polymer by emulsion polymerization in order to effectively reduce the amount of the residual maleimide monomer.

The acrylic resin composition according to one or more embodiments contains an ionic emulsifier. The ionic emulsifier may be one that is used in emulsion polymerization for production of the acrylic polymer and that remains in the acrylic polymer.

If the acrylic polymer is collected from the reaction system after the emulsion polymerization by means of washing with water or an organic solvent, the ionic emulsifier is washed off and in consequence the collected acrylic polymer contains substantially no ionic emulsifier.

Thus, in production of the acrylic resin composition according to one or more embodiments, it is preferable to perform a drying process on the reaction system after the emulsion polymerization without performing any washing process. The acrylic polymer collected only by means of the drying process contains the ionic emulsifier and can be used by itself as the acrylic resin composition according to one or more embodiments.

It is preferable not to perform any washing process in terms of energy cost and productivity. In the case where any washing process is not performed, the ionic emulsifier used in the emulsion polymerization remains in the resulting acrylic polymer, and thus the total amount of the ionic emulsifier used in the emulsion polymerization is substantially equal to the amount of the ionic emulsifier contained in the acrylic resin composition. In the emulsion polymerization, the ionic emulsifier may be added at one time or in batches.

Despite the fact that the acrylic resin composition according to one or more embodiments contains the emulsifier remaining therein, the formation of bubble marks on the film surface can be reduced because the emulsifier is an ionic emulsifier. In contrast, if a non-ionic emulsifier remains and is contained in the resin composition, bubble marks are likely to be formed on the film surface.

The ionic emulsifier may be any of cationic, anionic, and zwitterionic emulsifiers. Among these, anionic emulsifiers are preferred. Any non-ionic emulsifier is not classified as the ionic emulsifier.

The ionic emulsifier is not limited to a particular type and may be any ionic emulsifier the use of which can provide an acrylic resin composition that can exhibit the effect of one or more embodiments of the invention. The ionic emulsifier used may be a known ionic emulsifier. Examples of the ionic emulsifier include carboxylate salts, sulfonate salts, sulfuric ester-based emulsifiers, and phosphoric ester-based emulsifiers. Sulfonate salts are preferred in order to significantly reduce the formation of bubble marks during drying in film production and ensure high polymerization stability.

Specific examples of sulfonate salts include dialkyl sulfosuccinate salts, alkane sulfonate salts, α-olefin sulfonate salts, alkylbenzene sulfonate salts, naphthalene sulfonate salt-formaldehyde condensates, alkylnaphthalene sulfonate salts, and N-methyl-N-acyl taurine salts. Among these, dialkyl sulfosuccinate salts or alkylbenzene sulfonate salts are preferred.

The sulfonate salt used is not limited to a particular type and may be any sulfonate salt by the use of which the effect of one or more embodiments of the invention can be achieved. The sulfonate salt used may be, for example, a lithium salt, a sodium salt, a potassium, a calcium salt, or a magnesium salt. In particular, in terms of effectively reducing the formation of bubble marks, the sulfonate salt used may include at least one selected from the group consisting of a lithium salt, a sodium salt, and a potassium salt. In the case where the sulfonate salt is in the form of such a monovalent cation salt, it is expected that, when the salt remains in the acrylic resin composition, the salt dissolves in an alcohol component of a dope solvent and is microscopically dispersed in the solution dope. Thus, bubble formation can be controlled to a microscopic level.

One or more embodiments are less constrained by the amount of the ionic emulsifier used in polymerization, and the range of design choices for the polymerization can be extended. Additionally, it is possible not only to reduce the number of washing steps but also to employ a polymer acquisition method that does not require washing, such as a granulation method as exemplified by spray drying. Thus, the productivity in acrylic resin production can be considerably improved.

In the case where the sulfonate salt is a salt with a multivalent cation, such as a calcium ion salt or magnesium salt, the sulfonate salt tends to be insoluble in alcohol components. Thus, in terms of reducing the formation of bubble marks during drying in film production, it is preferable, for example, to coagulate an emulsion polymerization-produced polymer latex with a coagulant, heat-treat the coagulated latex, and wash the resulting slurry particles by a known washing method to reduce the amount of the salt contained in the acrylic resin composition to some extent.

The content of the ionic emulsifier may be from 0.1 to 10 parts by weight per 100 parts by weight of the acrylic polymer. In terms of reducing the formation of bubble marks during drying in film production and achieving a good balance between the reduction in the formation of bubble marks and the polymerization stability, the content of the ionic emulsifier may be from 0.3 to 7 parts by weight, from 0.4 to 6 parts by weight, from 0.5 to 5 parts by weight, from 0.8 to 3 parts by weight, or from 1 to 3 parts by weight. If the content of the ionic emulsifier is more than 10 parts by weight, the effect of reducing the formation of bubble marks in an acrylic resin film diminishes, and the transparency of the acrylic resin film could be reduced. There could also be a deterioration of physical properties other than those related to bubble formation, such as the thermal stability of the acrylic resin film. Additionally, during film production by solution casting, the salt could bleed onto a metal roll and thus soil the metal roll.

A known polymerization initiator may be used in polymerization for producing the acrylic polymer, and examples of the polymerization initiator include: persulfate salts such as potassium persulfate, sodium persulfate, and ammonium persulfate; and organic peroxides such as tert-butyl hydroperoxide, tert-butyl peroxyisopropylcarbonate, cumene hydroperoxide, p-menthane hydroperoxide, 1,1,3,3-tetramethylbutyl hydroperoxide, di-8,5,5-trimethylhexanoyl peroxide, dilauroyl peroxide, and benzoyl peroxide.

Any of these polymerization initiators may be cleaved only by a thermal decomposition mechanism to generate radicals and initiate the polymerization. Alternatively, as described in Examples of Japanese Patent No. 3960631, the polymerization initiator may be used as a redox initiator that generates radicals at low temperature by being combined with an oxidant such as iron(II) sulfate and a reductant such as sodium formaldehyde sulfoxylate. Coloring of the acrylic polymer can be prevented by combining an initiator, an oxidant, and a reductant appropriately for the composition of the acrylic polymer.

To control the molecular weight of the acrylic polymer, a known chain transfer agent may be used in polymerization for producing the acrylic polymer. Examples of the chain transfer agent include alkyl mercaptans, alkyl sulfides, alkyl disulfides, thioglycolic esters such as 2-ethylhexyl thioglycolate, α-methylstyrene dimer, mercapto acids such as β-mercaptopropionic acid, and aromatic mercaptans such as benzyl mercaptan, thiophenol, thiocresol, and thionaphthol.

(Graft Copolymer)

The acrylic resin composition according to one or more embodiments may further contain a graft copolymer having a core-shell structure. In preparation of a dope for solution casting, the acrylic resin composition and the graft copolymer having a core-shell structure may be individually added to a solvent. The graft copolymer having a core-shell structure can provide mechanical strength properties such as folding endurance and cracking resistance to the acrylic resin film.

The graft copolymer having a core-shell structure is what may be called a multi-stage polymer, multi-layered polymer, or core-shell polymer. Such a polymer is composed of crosslinked polymer particles (core layers) and polymer layers (shell layers) formed by polymerization of a monomer mixture in the presence of the crosslinked polymer particles (core layers). Each of the core and shell layers may consist of a single layer or may be made up of two or more layers. The graft copolymer used is not limited to a particular type, and a known graft copolymer may be used as appropriate. One example is a graft copolymer obtained by polymerizing a monomer mixture containing an acrylic ester as a main component with a crosslinking agent to form a rubbery acrylic ester polymer and then polymerizing a monomer mixture containing a methacrylic ester as a main component in the presence of the rubbery acrylic ester polymer.

The graft copolymer can be produced by a common emulsion polymerization process using a known emulsifier. In terms of reducing the formation of bubble marks in the acrylic resin film during drying in film production, the graft copolymer may be produced by emulsion polymerization using an ionic emulsifier soluble in alcohols.

For example, in the case where the graft copolymer is granulated using a coagulant such as calcium chloride or magnesium chloride, the ionic emulsifier is in the form of a multivalent cation salt. Thus, in terms of reducing the formation of bubble marks in the resin film, it is preferable to wash the graft copolymer using a known washing method and thus reduce the amount of the salt contained in the graft copolymer.

As to the blend ratio between the acrylic polymer and the graft copolymer having a core-shell structure in the acrylic resin composition, the amount of the graft copolymer may be from 1 to 50 parts by weight, from 5 to 40 parts by weight, or from 7 to 30 parts by weight per 100 parts by weight of the acrylic polymer.

When the amount of the graft copolymer having a core-shell structure is 1 part by weight or more, the addition of the graft copolymer having a core-shell structure can offer a strengthening effect. When the amount of the graft copolymer is 50 parts by weight or less, the acrylic resin film is excellent in heat resistance and elastic modulus, and the workability during film production is also good.

The graft copolymer used may be one which, when dissolved or dispersed in a solvent used in a solution dope, is hardly swelled with the solvent. For example, with the use of a graft copolymer in which the crosslinked polymer forming the core layers has a high crosslink density, it is expected that entry of the solvent into the core layers and hence swelling of the graft copolymer are prevented, that the molecular chain density of the shell layers does not therefore decrease and the interparticle steric repulsion is maintained, and that this results in good particle dispersibility.

The acrylic resin composition according to one or more embodiments contains an ionic emulsifier. Thus, in the case where the composition further contains graft copolymer particles having a core-shell structure, the graft copolymer particles are prevented from being aggregated together and are dispersed well in the composition. There is also a contribution to improvement in the stability over time of a solution dope (the resistance to aggregation during long-term storage).

(Other Components)

In production of an acrylic resin film by solution casting, the acrylic resin composition may be optionally mixed with one or more of the following components to prepare a solution dope: known additives such as a light stabilizer, an ultraviolet absorber, a thermal stabilizer, an antioxidant, a matting agent, a light diffusing agent, a colorant, a dye, a pigment, an antistatic agent, a heat reflecting agent, a lubricant, a plasticizer, and a filler; and other resins, including styrene resins such as an acrylonitrile-styrene resin, a methyl methacrylate-styrene resin, and a styrene-maleic anhydride resin, polycarbonate resins, polyvinyl acetal resins, cellulose acylate resins, fluororesins such as polyvinylidene fluoride and a polyfluoroalkyl (meth)acrylate resin, silicone resins, polyolefin resins, polyethylene terephthalate resins, and polybutylene terephthalate resins. For the purpose of adjusting the orientation birefringence of the film to be formed, the acrylic resin composition may be mixed with birefringent inorganic fine particles as described in Japanese Patent No. 3648201 or Japanese Patent No. 4336586 or with a birefringent low-molecular-weight compound as described in Japanese Patent No. 3696649 which has a molecular weight of 5000 or less, preferably 1000 or less.

(Solution Casting)

The acrylic resin composition according to one or more embodiments is used to produce a resin film by solution casting. Specifically, a solution dope is prepared by dissolving the acrylic resin composition in a so-called good solvent in which the acrylic resin composition is well soluble, then the prepared dope is cast onto the surface of a support, and finally the solvent is evaporated. In this manner, a resin film can be produced.

The good solvent is not limited to a particular type and may be any solvent in which the acrylic resin composition is soluble. Examples of the good solvent include chlorinated organic solvents such as methylene chloride and non-chlorinated organic solvents such as methyl acetate, ethyl acetate, acetone, methyl ethyl ketone, and tetrahydrofuran. Among these, methylene chloride is a preferred example since it is capable of dissolving the acrylic resin composition well.

An alcohol as a poor solvent may be added to the solution dope in addition to the good solvent. Examples of the alcohol include linear or branched aliphatic alcohols having 1 to 4 carbon atoms. Among such alcohols, ethanol and/or methanol is preferred.

The addition of the alcohol increases the efficiency of drying of the dope. Additionally, the evaporated alcohol leaves a large number of voids at sites of the film where the alcohol was present, and thus the film becomes less dense, so that the resulting film has high adhesive strength to a base material such as a polarizer.

The amount of the alcohol added may be from 1 to 25 wt %, from 2 to 20 wt %, or from 3 to 15 wt % based on the total amount of the solvents added to the dope.

Examples of the method for solution dope preparation include: a method in which pellets containing the acrylic resin composition and optionally other components such as a graft copolymer are made first and then the pellets are mixed with a solvent to prepare a solution dope containing the components dissolved or dispersed in the solvent; a method in which the components are individually added to a solvent and are mixed together to prepare a solution dope; and a method in which two or more types of dope precursor liquids are prepared and mixed together to prepare a solution dope. Among these, the method preferred in terms of achieving uniform mixing and dispersion of the components in the solution dope is that in which pellets containing the acrylic resin composition and optionally other components such as a graft copolymer are made first and then the pellets are mixed with a solvent to prepare a solution dope containing the components dissolved or dispersed in the solvent.

The resulting solution dope needs to contain little undissolved matter and have high transparency in itself in order to reduce the formation of bubble marks on the film surface during drying in film production and obtain a resin film having high transparency. Matter undissolved in the alcohol component is a cause of bubble marks, and the presence or absence of such matter can be detected before film production by evaluating the transparency of the solution dope.

One method for evaluating the transparency of a solution dope containing the dissolved acrylic resin composition is to measure the haze of a solution dope prepared by dissolving the acrylic resin composition at a given solids concentration in a solvent mixture containing a good solvent and an alcohol as a poor solvent in given proportions.

The acrylic resin composition according to one or more embodiments may be such that the haze of a dope containing the composition dissolved at a concentration of 5 wt % in a solvent mixture of 95 wt % methylene chloride and 5 wt % methanol is 5% or less. When the acrylic resin composition, with which a solution dope having a low haze can be prepared, is used to produce a resin film by solution casting, the film obtained is not likely to have on its surface bubble marks formed during drying in the film production and can have a good appearance and high transparency.

The step of dissolving the acrylic resin composition to prepare a dope may be carried out at a temperature and pressure controlled as appropriate. After the dissolving step, the resulting solution dope may be filtered or degassed. Subsequently, the solution dope is fed to a pressure die by means of a feed pump and cast from the slit of the pressure die onto the surface (mirror-finished surface) of a support such as an endless belt or a drum made of metal or synthetic resin, and thus a dope layer is formed on the surface of the support. The dope layer formed is heated on the support to evaporate the solvent and thus form a film. The temperature conditions for the solvent evaporation can be chosen as appropriate depending on the boiling point of the solvent used. The film thus obtained is peeled from the support. Where appropriate, the obtained film may subsequently be subjected to other steps such as a drying step, a heating step, and a stretching step.

(Resin Film)

A resin film according to one or more embodiments is formed by solution casting using a solution dope as described above. The thickness of the resin film is not limited to a particular range, but may be from 5 to 200 μm or from 5 to 100 μm. When the thickness of the resin film is 200 μm or less, the film can be uniformly cooled after being formed, and thus the optical properties tend to be uniform over the entire film or the drying speed of the film tends to be high. When the thickness of the resin film is 5 μm or more, the resin film tends to be easy to handle and tends to function well as a protective film.

The haze of the resin film, as measured when the thickness of the film is 40 μm, may be 2% or less, 1.5% or less, 1% or less, 0.8% or less, 0.6% or less, or 0.4% or less. When the haze falls within this range, the transparency of the resin film is so high that the resin film can be suitably used in an optical member required to have light permeability.

The resin film formed by molding the acrylic resin composition according to one or more embodiments by solution casting may be used as a protective film to be disposed on the surface of a base material, used as an optical film, or used as a polarizer protective film.

In the case where the resin film is used as a polarizer protective film, parameters indicative of the optical isotropy of the resin film may be small. In particular, it is preferable that not only a parameter indicative of the optical isotropy in the in-plane directions (length and width directions) of the resin film but also a parameter indicative of the optical isotropy in the thickness direction of the resin film be small.

Specifically, the absolute value of the in-plane retardation may be 10 nm or less, 5 nm or less, or 3 nm or less. The absolute value of the out-of-plane retardation may be 50 nm or less, 20 nm or less, 10 nm or less, or 5 nm or less. The resin film with such retardations is suitable for use as a polarizer protective film of a polarizing plate of a liquid crystal display device.

The retardations are parameters calculated based on birefringence. The in-plane retardation (Re) and the out-of-plane retardation (Rth) can be calculated by the equations given below, respectively. For an ideal molded article with perfect optical isotropy in three-dimensional directions, both the in-plane retardation (Re) and the out-of-plane retardation (Rth) are zero.

Re=(nx−ny)×d

Rth=((nx+ny)/2−nz)×d

In the equations, nx denotes a refractive index in an X-axis direction that is an in-plane direction in which the molded article extends (the direction of polymer chain orientation), ny denotes a refractive index in a Y-axis direction perpendicular to the X-axis direction, and nz denotes a refractive index in a Z-axis direction that is the thickness direction of the film. The letter d denotes the thickness of the molded article, and nx−ny denotes the orientation birefringence. The MD direction of the molded article is the X-axis direction. In the case where the molded article is a stretched molded article, the stretching direction is the X-axis direction.

For the resin film formed by molding the acrylic resin composition according to one or more embodiments by solution casting, the orientation birefringence may be from −2.6×10⁻⁴ to 2.6×10⁻⁴, from −1.7×10⁻⁴ to 1.7×10⁻⁴, from −1.0×10⁻⁴ to 1.0×10⁻⁴, from −0.5×10⁻⁴ to 0.5×10⁻⁴, or from −0.2×10⁻⁴ to 0.2×10⁻⁴. When the orientation birefringence is within the above range, no birefringence occurs during molding, and stable optical properties can be achieved. In this case, the resin film is very suitable as an optical film for use in a liquid crystal display or the like.

For the resin film formed by molding the acrylic resin composition according to one or more embodiments by solution casting, the photoelastic coefficient may be from −6×10⁻¹² to 6×10⁻¹² Pa⁻¹, from −4×10⁻¹² to 4×10⁻¹² Pa⁻¹, from −2×10⁻¹² to 2×10⁻¹² Pa⁻¹, from −1×10⁻¹² to 1×10⁻¹² Pa⁻¹, from −0.5×10⁻¹² to 0.5×10⁻¹² Pa⁻¹, or from −0.2×10⁻¹² to 0.2×10⁻¹² Pa⁻¹.

Photoelastic birefringence is a birefringence caused when a polymer in a molded article undergoes an elastic deformation (strain) in response to a stress applied to the molded article. In practice, the degree of photoelastic birefringence of the polymer material can be evaluated by determining the photoelastic coefficient specific to the polymer itself. First, a stress is applied to the polymer material to induce an elastic strain in the polymer material, and the corresponding birefringence is measured. The constant of proportionality between the measured birefringence and the stress is the photoelastic coefficient. By examining the photoelastic coefficient, the birefringence caused upon application of the stress to the polymer can be evaluated. When the photoelastic coefficient is in the range as mentioned above, no birefringence occurs even in the event that the molded article deforms due to a stress acting on it. This can result in the molded article for which the parameters indicative of the optical isotropy are small. For example, in the case of using the molded article as a polarizer protective film, the stable optical properties of the polarizer protective film are maintained even in the event that panel deformation occurs under the effect of air moisture or temperature during transportation, and thus quality risks such as degradation in image quality can be reduced.

### EXAMPLES

Hereinafter, one or more embodiments of the present invention will be specifically described using examples. One or more embodiments of the present invention are not limited to the examples given below. The methods used to test or evaluate the physical properties in the examples and comparative examples are as described below.

(1) Weight-Average Molecular Weight (Mw)

The weight-average molecular weight (Mw) of the acrylic polymer was calculated by a standard polystyrene-equivalent method using gel permeation chromatography (GPC). The GPC column used was one packed with a crosslinked polystyrene gel (product name: Shodex GPC K-806M, manufactured by Showa Denko K.K.), and the GPC solvent used was chloroform. The sample solution was prepared by dissolving 5 mg of a resin powder made of the acrylic resin composition in 2 ml of chloroform, and the column temperature was set to 40° C.

(2) Volume Mean Diameter of Polymer Latex

The volume mean diameter of the polymer latex of the acrylic polymer was determined using Microtrac UPA150 (manufactured by Nikkiso Co., Ltd.) based on the principle of dynamic light scattering method.

(3) Volume Mean Diameter of Bead Particles

The volume mean diameter of the bead particles was determined using Microtrac MT3300EXII (manufactured by Nikkiso Co., Ltd.) based on the principle of laser diffraction-scattering method.

(4) Glass Transition Temperature (Tg)

The glass transition temperature (Tg) of the acrylic polymer was measured using a differential scanning calorimeter (DSC, product name: Q1000 manufactured by TA instruments). The sample was placed in a stream of nitrogen, heated to 200° C. at a temperature rise rate of 10° C./min, then rapidly cooled to 40° C., and heated again to 200° C. at a temperature rise rate of 10° C./min. For the glass transition observed during the second heating, the average of the extrapolated glass transition onset temperature and the extrapolated glass transition end temperature was determined, and this average was used as the glass transition temperature (Tg).

(5) Test of Solubility of Surfactant in Methanol

An amount of 15 mg of the surfactant used for acrylic polymer production was weighed out (in the case where the surfactant was a liquid, it was evaporated to dryness to obtain a dry powder) and added to 10 ml of methanol, and the solubility in methanol was visually inspected. The solubility was rated according to the following criteria.
Good (soluble)
Average (soluble, but dissolution takes a lot of time)
Poor (insoluble)

“Good (soluble)” means that the dry surfactant powder added to and shaken in methanol quickly dissolves in the methanol. “Average (soluble, but dissolution takes a lot of time)” means that the dry surfactant powder added to methanol shows no change for some time, but after being shaken continuously for a certain time, gradually begins to dissolve and finally dissolves completely. “Poor (insoluble)” means that the dry surfactant powder does not dissolve even when being shaken continuously.

(6) Measurement of Haze of Solution Dope

A solvent mixture containing methylene chloride and methanol at a methylene chloride:methanol weight ratio of 95:5 was prepared, and a powder of the acrylic resin composition was added to the solvent mixture to give a solids concentration of 5 wt %. The powder was then stirred with a stirrer tip in the solvent mixture to prepare a solution dope. The solution dope thus obtained was degassed. Subsequently, the haze of the solution dope was measured using a haze meter (HAZE Meter NDH4000 manufactured by Nippon Denshoku Industries Co., Ltd.) after zero setting in which the solvent mixture containing methylene chloride and methanol at a methylene chloride:methanol weight ratio of 95:5 was used as a standard sample.

(7) Evaluation of Bubble Marks of Acrylic Resin Film

A solvent mixture containing methylene chloride and methanol at a methylene chloride:methanol weight ratio of 80:20 was prepared, and the acrylic resin composition was added to the solvent mixture to give a solids concentration of 10 wt %. The composition was then stirred with a stirrer tip in the solution mixture to prepare a solution dope. Subsequently, a 1.1-mm-thick layer of the solution dope was formed on a glass sheet by solution casting with the aid of a bar coater, and the layer of the solution dope was left on the glass sheet for 10 minutes. The film thus obtained was then quickly cut into a piece with a size of 5.5 cm×5.5 cm, and the film piece held by a metal frame with a size of 6 cm×6 cm was placed into a drying oven set to 190° C. and was dried for 10 minutes.

After the film was taken out of the drying oven, the surface of that portion of the film at which the film was held by the metal frame was observed with an optical microscope. In the case where the degree of film bubble formation was severe, the portion of the film that was directly exposed to hot air in the drying oven whitened (bubble formation), and this indicates that the drying conditions were harsh. In contrast, that portion of the film at which the film was held by the metal frame suffered less from bubble formation despite the harshness of the drying conditions, and for this portion the formation of bubble marks was able to be accurately detected in a manner like an accelerated test.

Sensory evaluation was conducted on the state of bubble marks on the film surface observed with an optical microscope. The state of bubble marks on the film surface visually inspected was scored on the scale of 1 (poor) to 5 (good) according to the following criteria.
1 (There are bubble marks over the entire surface.)
2 (There are many bubble marks although they are not distributed over the entire surface.)
3 (There are bubble marks on the surface, but the number of them is small.)
4 (The surface is generally clean although there are a few bubble marks on the surface.)
5 (The surface is free of bubble marks and very clean.)

(8) Measurement of Haze of Acrylic Resin Film

A solvent mixture containing methylene chloride and methanol at a methylene chloride:methanol weight ratio of 80:20 was prepared, and the acrylic resin composition was added to the solvent mixture to give a solids concentration of 10 wt %. The composition was then stirred with a stirrer tip in the solution mixture to prepare a solution dope. Subsequently, a 1.1-mm-thick layer of the solution dope was formed on a glass sheet by solution casting with the aid of a bar coater, and the layer of the solution dope was left on the glass sheet for 10 minutes. The resulting film was peeled from the glass sheet and measured for its thickness. The average thickness of the film was 40 μm. The haze of the film was measured using a haze meter (HZ-V3 manufactured by Suga Test Instruments Co., Ltd.) according to the method as specified in JIS K 7105.

Hereinafter, the examples of one or more embodiments of the invention will be described in detail. Unless otherwise stated, the word “part(s)” and the symbol “%” refer to “part(s) by weight” and “wt %”, respectively. The abbreviations denote the following substances, respectively.
MMA: Methyl methacrylate
BMA: n-Butyl methacrylate
2-EHMA: 2-Ethylhexyl methacrylate
PhMI: N-Phenylmaleimide
DSS: Sodium dioctyl sulfosuccinate
DBS: Sodium dodecylbenzenesulfonate
NPS: Sodium persulfate
NDS: Sodium pyrosulfite
SFS: Sodium formaldehyde sulfoxylate
ED: Disodium ethylenediaminetetraacetate
FeSO₄: Iron(II) sulfate heptahydrate
2-EHTG: 2-Ethylhexyl thioglycolate
LPO: Lauroyl peroxide
t-BHP: t-Butyl hydroperoxide
PSF: Potassium hydrogenated tallowate
HPMC: Hydroxypropyl methylcellulose

### Example 1: Production of Acrylic Polymer A

An 8-liter glass reactor equipped with a paddle stirrer was charged with 143 parts of deionized water, 0.01 parts of sodium hydroxide, and 0.005 parts of DSS. Subsequently, stirring of the reactor contents was started at 175 rpm, and the interior of the reactor was heated to 80° C. under a nitrogen purge. After heating up to 80° C., 0.03 parts of NPS and 0.001 parts of NDS were added. Subsequently, a monomer mixture of 90 parts of MMA, 10 parts of BMA, and 0.015 parts of 2-EHTG was added to the reactor continuously over 80 minutes to allow the reaction to proceed. Dropwise addition of 0.495 parts of DSS to the reactor was started at 15 minutes after the start of the addition of the monomer mixture and continued along with the addition of the monomer mixture. The stirring speed was increased to 200 rpm at 50 minutes after the start of the addition of the monomer mixture and to 240 rpm at 70 minutes after the start of the addition of the monomer mixture. After the end of the addition of the monomer mixture, the reaction was continued for 60 minutes to complete the polymerization. Thus, a polymer latex was obtained. The polymerization conversion percentage was 99.5%, and the mean particle diameter was 4500 Å. Subsequently, the polymer latex obtained was evaporated to dryness by a drying oven at 75° C. for 12 hours, and as a result an acrylic polymer A-containing resin composition was obtained in the form of a white powder. The weight-average molecular weight of the acrylic polymer A was 100×10⁴, and the solubility in methanol of DSS used for the polymerization was rated “Good (soluble)”. The acrylic polymer A-containing resin composition contains 0.5 parts by weight of DSS per 100 parts by weight of the acrylic polymer A.

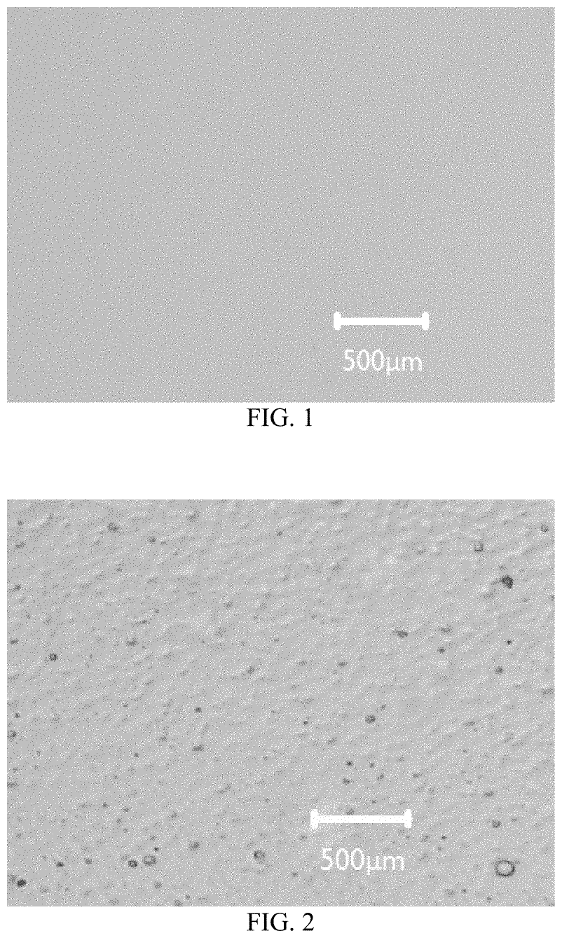

The haze of a solution dope prepared with the white powder of the acrylic polymer A-containing resin composition was 0.7%. For an acrylic resin film produced by solution casting using the white powder of the acrylic polymer A-containing resin composition, the bubble formation level as evaluated by visual inspection was scored 5, and the haze was 0.22%. The results are listed in Table 1. A microscope image of the film surface subjected to the bubble formation level evaluation is shown in FIG. 1.

### Example 2: Production of Acrylic Polymer B

A polymer latex was obtained by performing polymerization in the same manner as in Example 1, except that the amount of DSS added continuously to the reactor was changed to 4.995 parts. The polymerization conversion percentage was 99.7%, and the mean particle diameter was 4300 Å. The polymer latex obtained was processed in the same manner as in Example 1 to obtain an acrylic polymer B-containing resin composition in the form of a white powder. The weight-average molecular weight of the acrylic polymer B was 110×10⁴. The acrylic polymer B-containing resin composition contains 5.0 parts by weight of DSS per 100 parts by weight of the acrylic polymer B. The surfactant solubility in methanol, the solution dope haze, the film bubble formation level, and the film haze were evaluated in the same manner as in Example 1. The results are listed in Table 1.

### Example 3: Production of Acrylic Polymer C

A polymer latex was obtained by performing polymerization in the same manner as in Example 2, except that DSS was replaced by DBS. The polymer latex obtained was processed in the same manner as in Example 2 to obtain an acrylic polymer C-containing resin composition in the form of a white powder. The weight-average molecular weight of the acrylic polymer C was 90×10⁴. The acrylic polymer C-containing resin composition contains 5.0 parts by weight of DBS per 100 parts by weight of the acrylic polymer C. The surfactant solubility in methanol, the solution dope haze, the film bubble formation level, and the film haze were evaluated in the same manner as in Example 1. The results are listed in Table 1.

### Example 4: Production of Acrylic Polymer D

An 8-liter glass reactor equipped with a paddle stirrer was charged with 143 parts of deionized water, 0.01 parts of sodium hydroxide, and 0.15 parts of DSS. Subsequently, stirring of the reactor contents was started at 175 rpm, and the interior of the reactor was heated to 85° C. under a nitrogen purge. After heating up to 85° C., 0.022 parts of NPS and 0.0005 parts of SFS were added. Subsequently, a monomer mixture of 85 parts of MMA, 5 parts of 2-EHMA, and 10 parts of PhMI was added to the reactor continuously over 80 minutes to allow the reaction to proceed. Dropwise addition of 0.55 parts of DSS to the reactor was started at 15 minutes after the start of the addition of the monomer mixture and continued along with the addition of the monomer mixture. The stirring speed was increased to 200 rpm at 55 minutes after the start of the addition of the monomer mixture and to 240 rpm at 70 minutes after the start of the addition of the monomer mixture. After the end of the addition of the monomer mixture, an aqueous solution mixture of 0.0055 parts of ED and 0.0015 parts of FeSO₄, 0.03 parts of SFS, 0.3 parts of DSS, and 0.03 parts of t-BHP were sequentially added to the reactor. After that, the reaction was continued for 60 minutes to complete the polymerization. Thus, a polymer latex was obtained. The polymerization conversion percentage was 99.9%, and the mean particle diameter was 2000 Å. Subsequently, the polymer latex obtained was evaporated to dryness by a drying oven at 75° C. for 12 hours, and as a result an acrylic polymer D-containing resin composition was obtained in the form of a white powder. The weight-average molecular weight of the acrylic polymer D was 175×10⁴. The acrylic polymer D-containing resin composition contains 1.0 parts by weight of DSS per 100 parts by weight of the acrylic polymer D. The surfactant solubility in methanol, the solution dope haze, the film bubble formation level, and the film haze were evaluated in the same manner as in Example 1. The results are listed in Table 1.

### Example 5: Production of Acrylic Polymer E

A polymer latex was obtained by performing polymerization in the same manner as in Example 2, except that DSS was replaced by PSF. The polymer latex obtained was processed in the same manner as in Example 2 to obtain an acrylic polymer E-containing resin composition in the form of a white powder. The weight-average molecular weight of the acrylic polymer E was 100×10⁴. The acrylic polymer E-containing resin composition contains 5.0 parts by weight of PSF per 100 parts by weight of the acrylic polymer E. The surfactant solubility in methanol, the solution dope haze, the film bubble formation level, and the film haze were evaluated in the same manner as in Example 1. The results are listed in Table 1.

### Comparative Example 1: Production of Acrylic Polymer F

An 8-liter glass reactor equipped with a paddle stirrer was charged with 170 parts of deionized water and 0.1 parts of disodium hydrogen phosphate anhydrous. Subsequently, stirring of the reactor contents was started at 300 rpm, and the interior of the reactor was heated to 40° C. under a nitrogen purge. After 0.3 parts of LPO was added to the reactor, a monomer mixture of 90 parts of MMA, 10 parts of BMA, and 0.02 parts of 2-EHTG was added to the reactor continuously over 30 minutes. After 30 minutes following the end of the addition of the monomer mixture, 0.4 parts of HPMC (METOLOSE 60SH50 manufactured by Shin-Etsu Chemical Co., Ltd.) was added to the reactor continuously over 30 minutes. After 30 minutes, the interior of the reactor was heated, and the reaction was started once the internal temperature of the reactor reached 65° C. The internal temperature of the reactor reached a maximum of 85° C. at 100 minutes after the start of the reaction, and then decreased slowly. After that, the internal temperature of the reactor was increased to 95° C. and held at 95° C. for 60 minutes to complete the polymerization. The volume mean diameter of the resulting bead particles was 50 μm. The slurry suspension containing the bead particles was evaporated to dryness by a drying oven at 50° C. for 24 hours, and as a result an acrylic polymer F-containing resin composition was obtained. The weight-average molecular weight of the acrylic polymer F was 100×10⁴. The acrylic polymer F-containing resin composition contains 0.4 parts by weight of HPMC per 100 parts by weight of the acrylic polymer F. HPMC is a non-ionic surfactant and does not fall under the category of ionic emulsifiers. The surfactant solubility in methanol, the solution dope haze, the film bubble formation level, and the film haze were evaluated in the same manner as in Example 1. The results are listed in Table 1. A microscope image of the film surface subjected to the bubble formation level evaluation is shown in FIG. 2.

TABLE 1

| | | | | | | | Comparative |
|---|---|---|---|---|---|---|---|
| | | Example 1 | Example 2 | Example 3 | Example 4 | Example 5 | Example 1 |
| Acrylic polymer | | Polymer A | Polymer B | Polymer C | Polymer D | Polymer E | Polymer F |
| Polymerization method | | Emulsion | Emulsion | Emulsion | Emulsion | Emulsion | Suspension |
| | | poly- | poly- | poly- | poly- | poly- | poly- |
| | | merization | merization | merization | merization | merization | merization |
| Surfactant | Type | DSS | DSS | DBS | DSS | PSF | HPMC |
| | Total amount | 0.5 | 5.0 | 5.0 | 1.0 | 5.0 | 0.4 |
| | (parts by weight) | | | | | | |
| | Solubility | Good | Good | Good | Good | Good | Poor |
| | in methanol | | | | | | |
| Method for obtaining powder | | Evaporation | Evaporation | Evaporation | Evaporation | Evaporation | Evaporation |
| | | to dryness | to dryness | to dryness | to dryness | to dryness | to dryness |
| | | (without | (without | (without | (without | (without | (without |
| | | washing) | washing) | washing) | washing) | washing) | washing) |
| Glass transition temperature | | 115 | 115 | 115 | 125 | 115 | 114 |
| of powder [° C.] | | | | | | | |
| Solution dope haze [%] | | 0.7 | 1.4 | 0.3 | 0.05 | 4.7 | 8.1 |
| Film haze [%] | | 0.22 | 0.38 | 0.57 | 0.25 | 1.64 | 0.54 |
| Filmbubble | Score (poor | 5 | 5 | 5 | 5 | 4 | 2 |
| formation level | 1 to 5 good) | | | | | | |

Table 1 reveals that the haze of the solution dopes prepared with the acrylic polymer A- to E-containing resin compositions of Examples 1 to 5 was not more than 5% and that the acrylic resin films produced by solution casting using the compositions were very superior in terms of bubble formation level and had a clean appearance. It is also seen that the haze of the acrylic resin films was not more than 2% and thus that the films had high transparency. Such an acrylic resin film having a clean appearance and high transparency is suitable for use as an optical film such as a polarizer protective film.

As for the acrylic polymer F-containing resin composition of Comparative Example 1 which contained no ionic emulsifier but contained a non-ionic surfactant, the haze of the solution dope prepared with this composition was more than 5%. Additionally, the acrylic resin film produced by solution casting using the composition received a low score as to the bubble formation level; that is, this film failed to have a clean appearance.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. An acrylic resin composition for use in film production by solution casting, the acrylic resin composition comprising:
an acrylic polymer comprising:
as structural units, 30 to 100 wt % of methyl methacrylate units and 0 to 70 wt % of other monomer units copolymerizable with the methyl methacrylate units; and
an ionic emulsifier,
wherein a content of the ionic emulsifier is from 0.1 to 10 parts by weight per 100 parts by weight of the acrylic polymer.

2. The acrylic resin composition for use in film production by solution casting according to claim 1, wherein the ionic emulsifier is a sulfonate salt.

3. The acrylic resin composition for use in film production by solution casting according to claim 2, wherein the sulfonate salt comprises at least one selected from the group consisting of a lithium salt, a sodium salt, and a potassium salt.

4. The acrylic resin composition for use in film production by solution casting according to claim 2, wherein the sulfonate salt comprises at least one selected from the group consisting of a dialkyl sulfosuccinate salt, an alkane sulfonate salt, an α-olefin sulfonate salt, an alkylbenzene sulfonate salt, a naphthalene sulfonate salt-formaldehyde condensate, an alkylnaphthalene sulfonate salt, and a N-methyl-N-acyl taurine salt.

5. The acrylic resin composition for use in film production by solution casting according to claim 1, wherein the other copolymerizable monomer units comprise (meth)acrylic ester units that are other than methyl methacrylate units and that have an ester moiety having 1 to 20 carbon atoms and/or maleimide units.

6. The acrylic resin composition for use in film production by solution casting according to claim 1, wherein a content of the other copolymerizable monomer units is from 0.1 to 50 wt % based on total structural units of the acrylic polymer.

7. The acrylic resin composition for use in film production by solution casting according to claim 1, further comprising 1 to 50 parts by weight of a graft copolymer having a core-shell structure per 100 parts by weight of the acrylic polymer.

8. The acrylic resin composition for use in film production by solution casting according to claim 1, wherein a weight-average molecular weight of the acrylic polymer is 50×10⁴ or more.

9. The acrylic resin composition for use in film production by solution casting according to claim 1, wherein a haze of a solution dope containing the acrylic resin composition at a concentration of 5 wt % in a solvent mixture of 95 wt % methylene chloride and 5 wt % methanol is 5% or less.

10. A resin film produced by molding the acrylic resin composition according to claim 1 by solution casting.

11. The resin film according to claim 10, wherein a haze of the resin film is 2% or less.

12. The resin film according to claim 10, wherein the resin film is a protective film to be disposed on a surface of a base material.

13. The resin film according to claim 10, wherein the resin film is a polarizer protective film.

14. A polarizing plate comprising:
a polarizer; and
the resin film according to claim 13, the resin film being disposed on the polarizer.

15. A display device comprising the polarizing plate according to claim 14.

16. A method for producing the acrylic resin composition according to claim 1, the method comprising:
performing emulsion polymerization or suspension polymerization in a presence of an ionic emulsifier to obtain a liquid mixture containing the acrylic polymer and water; and
performing a drying process on the liquid mixture without performing any washing process.

17. A resin film production method comprising forming a dope into a film by solution casting, wherein the dope comprises:
the acrylic resin composition according to claim 1; and
a solvent.

18. The resin film production method according to claim 17, wherein the solvent comprises 1 to 25 wt % of an alcohol.

19. The resin film production method according to claim 18, wherein the alcohol comprises ethanol and/or methanol.
